(19) United States
(12) Patent Application Publication
(10) Pub. No.: US 2006/0286967 A1
(43) Pub. Date: Dec. 21, 2006

(54) System and method for performing authentication in a communication system

(75) Inventors: Jin-Young Lee, Suwon-si (KR); Jai-Dong Kim, Yongin-si (KR); Ju-Young Jung, Seongnam-si (KR); Yun-Sang Park, Suwon-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/452,720

(22) Filed: Jun. 14, 2006

(30) Foreign Application Priority Data
Jun. 15, 2005 (KR) 2005-51403

(51) Int. Cl. H04M 1/66

(52) U.S. Cl. 455/411

(57) ABSTRACT

In a communication system, a terminal receives user information while an initial network entry operation is performed. The terminal transfers the received user information to an authentication server and receives an authentication information mapped to the user information required for the authentication from the authentication server. The terminal performs authentication with the authentication server using the received authentication information. Therefore, the terminal and the authentication server can securely share the authentication information, and the authentication server can easily change and manage the authentication information.

### PRIORITY

This application claims priority under 35 U.S.C. § 119 to an application entitled “System And Method For Performing Authentication In A Communication System” filed in the Korean Intellectual Property Office on Jun. 15, 2005 and assigned Serial No. 2005-51403, the contents of which are incorporated herein by reference.

### BACKGROUND OF THE INVENTION

1. Field of the Invention

The present invention generally relates to a communication system, and more particularly to a system and method for performing authentication in a communication system.

2. Description of the Related Art

At present, communication systems, such as for example, an Institute of Electrical and Electronics Engineers (IEEE) 802.16 communication system and a Telecommunication Technology Association (TTA) Wireless Broadband Internet (WiBro) communication system serving as Broadband Wireless Access (BWA) communication systems, provide broadband access services in which high-speed mobile Internet access and multimedia services are possible. Hereinafter, for convenience of explanation, it is assumed that the communication system is a BWA communication system.

In the BWA communication system, a user authentication scheme is set when a basic capability negotiation process is performed between a terminal and a Base Station (BS) while an initial network entry operation of the terminal is performed normally. The BWA communication system selects one of a Rivest-Shamir-Adleman (RSA) scheme and an Extensible Authentication Protocol (EAP) scheme as the user authentication scheme in the basic capability negotiation process according to the negotiation between the terminal and the BS.

Now, a structure of the communication system for the user authentication will be described with reference to FIG. 1. Referring to FIG. 1, a terminal 100 is connected to an Access Point (AP) 102 serving as an authenticator using the EAP scheme. Using the AP 102 and an internal network 104 of the communication system, the terminal 100 performs user authentication through communication with an authentication server 106.

Before user authentication is performed through communication with the authentication server 106, the terminal 100 cannot access a network other than the internal network 104. After user authentication is performed, the terminal 100 can access another network.

On the other hand, when EAP authentication is performed, the terminal 100 and the authentication server 106 require authentication information for user authentication before the authentication process is started. Herein, the EAP authentication is the authentication using the EAP scheme. The authentication information differs according to the EAP scheme. For example, a certificate corresponds to the authentication information when the EAP scheme uses a Transfer Layer Security pre-shared key (TLS) scheme, and an authentication key corresponds to the authentication information when the EAP scheme uses a Pre-Shared Key (PSK).

The terminal and the authentication server share the authentication information required for the user authentication. However, a concrete method for sharing the authentication information in the current BWA communication system has not been proposed.

On the other hand, in conventional methods for acquiring or sharing the authentication information required the user authentication, the authentication information is stored in advance in a terminal at its manufacturing time, or is acquired through a wired network before a wireless network is used. However, the conventional methods have a problem in that the terminal must transfer the authentication information stored at its manufacturing time to the authentication server or must access the wired network for wireless network access. A problem in security such as unlawful access to the authentication information may occur. When the authentication server desires to correct the authentication information or changes the authentication scheme, there is a problem in that the authentication information must be transferred to the terminal at every time.

Thus, a need exists for a user authentication method suitable for the BWA communication system while addressing the problems occurring in the conventional methods for acquiring and sharing the authentication information.

### SUMMARY OF THE INVENTION

When the terminal performs user authentication based on the EAP scheme through communication with the authentication server in the BWA communication system as described above, the terminal and the authentication server share in advance the authentication information required for user authentication.

This authentication information is securely shared to prevent it from being lost and stolen. Moreover, the authentication information must be able to be easily changed and managed in the authentication server.

Therefore, the present invention provides a system and method for performing authentication in a communication system. Moreover, the present invention provides a system and method for performing authentication in which a terminal and an authentication server can securely share authentication information in a communication system.

Moreover, the present invention provides a system and method for performing authentication in which an authentication server can easily change and manage authentication information in a communication system.

In accordance with an aspect of the present invention, there is provided a method for performing authentication in a terminal of a communication system, which includes receiving user information while an initial network entry operation is performed; transferring the received user information to an authentication server and receiving an authentication information mapped to the user information required for the authentication from the authentication server; and performing authentication with the authentication server using the received authentication information.

### BRIEF DESCRIPTION OF THE DRAWINGS

The above and other features and aspects of the present invention will be more clearly understood from the following detailed description taken in conjunction with the accompanying drawings, in which:

FIG. 1 illustrates a structure of a conventional communication system;

FIG. 2 illustrates an internal structure of a terminal in accordance with the present invention;

FIG. 3 is a flowchart illustrating a process for performing authentication in the terminal in accordance with the present invention;

FIG. 4 is a flowchart illustrating a process for performing authentication in an authentication server in accordance with the present invention; and

FIG. 5 is a signal flow diagram illustrating an initial network entry process to which authentication is applied in the communication system in accordance with the present invention.

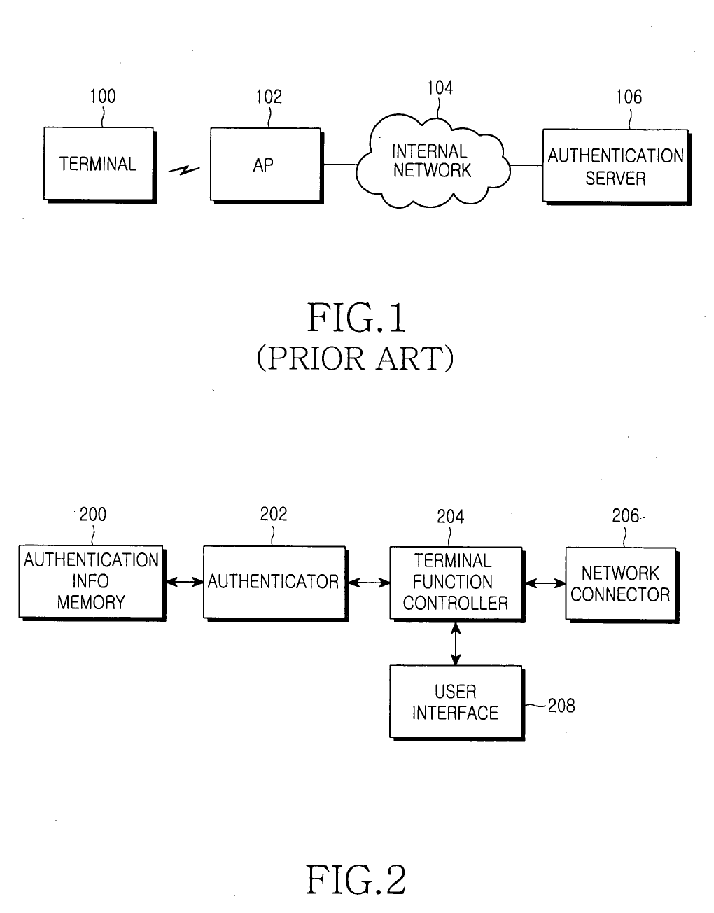

### DETAILED DESCRIPTION OF THE PREFERRED EMBODIMENTS

Preferred embodiments of the present invention will be described in detail herein below with reference to the accompanying drawings. In the following description, detailed descriptions of functions and configurations incorporated herein that are well known to those skilled in the art are omitted for clarity and conciseness.

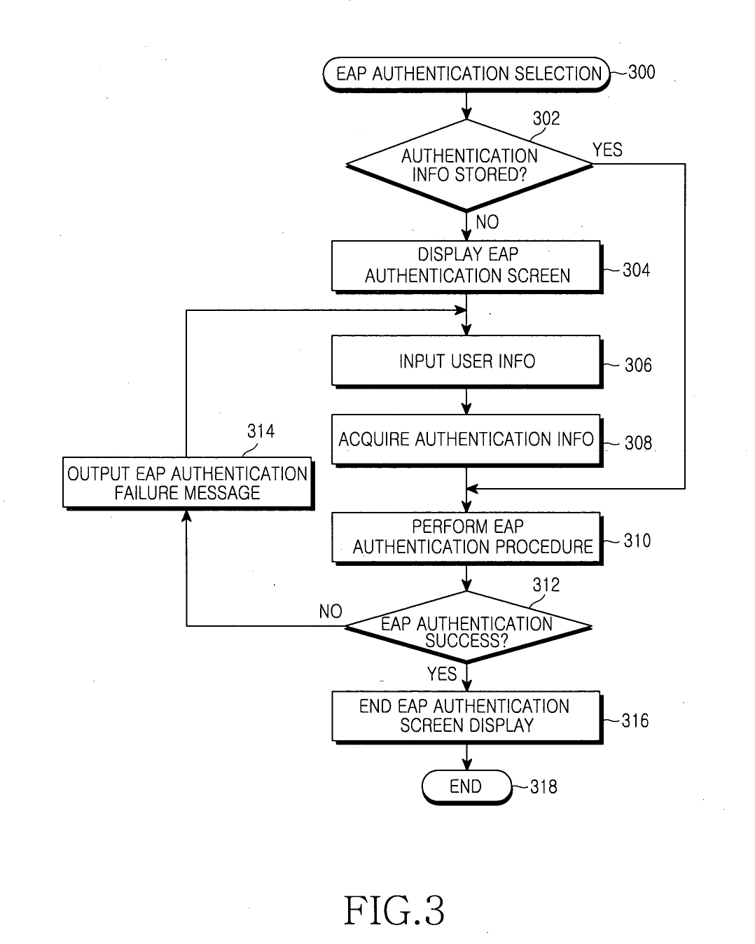

FIG. 2 illustrates an internal structure of a terminal in accordance with the present invention. The terminal is provided with an authentication information memory 200, an authenticator 202, a terminal function controller 204, a network connector 206, and a user interface 208. The authentication information memory 200 stores authentication information required for user authentication. Herein, the authentication information is acquired from an authentication server by means of the authenticator 202. While an initial network entry operation is performed, the terminal function controller 204 notifies the authenticator 202 of the start of a process using a Privacy Key Management (PKM)-Extensible Authentication Protocol (EAP) scheme. The authenticator 202 performs a user authentication procedure. When the user authentication is successful, the authenticator 202 notifies the terminal function controller 204 of the user authentication success. The operation of the authenticator 202 will be described below in detail with reference to FIG. 3.

The terminal function controller 204 controls the overall operation of the terminal. When the terminal is powered on, the terminal function controller 204 performs the initial network entry process. If the EAP scheme is selected as the user authentication scheme and a point of time of performing the PKM-EAP process is reached when basic capability negotiation with an Access Point (AP) is performed in the initial network entry process, the terminal function controller 204 notifies the authenticator 202 of the start of the PKM-EAP process. Subsequently, when the terminal function controller 204 is notified of the user authentication success, it notifies the network connector 206 of the authentication success and establishes a session.

After the terminal function controller 204 notifies the network connector 206 of the authentication success, the network connector 206 is responsible for an Internet Protocol (IP) allocation, a connection to a network, and so on. The user interface 208 provides various inputs including a user's key input to the terminal function controller 204 and various outputs including a display output.

FIG. 3 is a flowchart illustrating a process for performing authentication in the terminal in accordance with the present invention. The authentication process is performed in the authenticator 202 of FIG. 2. As EAP authentication is selected as a user authentication scheme when basic capability negotiation with an AP is performed in an initial network entry process, the terminal function controller 204 notifies the authenticator 202 of the start of a PKM-EAP process. The authenticator 202 starts the EAP authentication in step 300.

When the EAP authentication is started, the authenticator 202 determines whether authentication information is stored in the authentication information memory 200 in step 302. If the authentication information is stored in the authentication information memory 200, it corresponds to the case where the authentication information has been already acquired from the authentication server in the PKM-EAP process in the initial network entry process. Otherwise, if the authentication information is not stored in the authentication information memory 200, it corresponds to the case where the PKM-EAP process is performed in the first initial network entry process, or corresponds to the case where the authentication information stored in the authentication information memory 200 has been deleted.

If the authentication information is stored in the authentication information memory 200, the authenticator 202 communicates with the authentication server through the AP, requests the EAP authentication, and performs an EAP authentication procedure using the authentication information stored in the authentication information memory 200 in step 310. Otherwise, if the authentication information is not stored in the authentication information memory 200, the authenticator 202 displays an EAP authentication screen on the user interface 208 by means of the terminal function controller 204 in step 304. Herein, the EAP authentication screen is a screen for displaying user information input and authentication success. The user information is used to acquire the authentication information, and can be a user Identifier (ID) and password. While viewing the EAP authentication screen, the user inputs the user information. In an example of FIG. 3, both the user ID and password are used as the user information. Of course, one of the user ID and password may be selectively used as the user information.

Then, the authenticator 202 receives the user information from the user interface 208 by means of the terminal function controller 204 in step 306, and acquires the authentication information from the authentication server using the user information in step 308. At this time, the input user information is transferred to the authentication server through the AP and the authentication information is requested. The authentication information mapped to the user information is received from the authentication server. The authentication information acquired from the authentication server is stored in the authentication information memory 200. The authenticator 202 communicates with the authentication server through the AP, requests the EAP authentication, and performs an EAP authentication procedure using the authentication information acquired from the authentication server in step 310.

After step 310, the authenticator 202 performs step 314 or 316 according to a determination made as to whether the EAP authentication is successful in step 312. When an error occurs at the time of receiving the authentication information from the authentication server or the authentication information stored in the authentication information memory 200 is changed or updated, the EAP authentication fails. In this case, the authenticator 202 displays an EAP authentication failure message on the EAP authentication screen and requests that the user re-input the user information in step 314. Then, the process is re-performed from step 306. Otherwise, if the EAP authentication is successful, the authenticator 202 ends the operation for displaying the EAP authentication screen in step 316 and ends the EAP authentication in step 318.

If the EAP authentication is successful, the authenticator 202 notifies the terminal function controller 204 of the EAP authentication success. Then, the terminal function controller 204 notifies the network connector 206 of the authentication success and establishes a session. The network connector 206 performs an Internet Protocol (IP) allocation and establishes a connection to a network, such that initial network access will be successful.

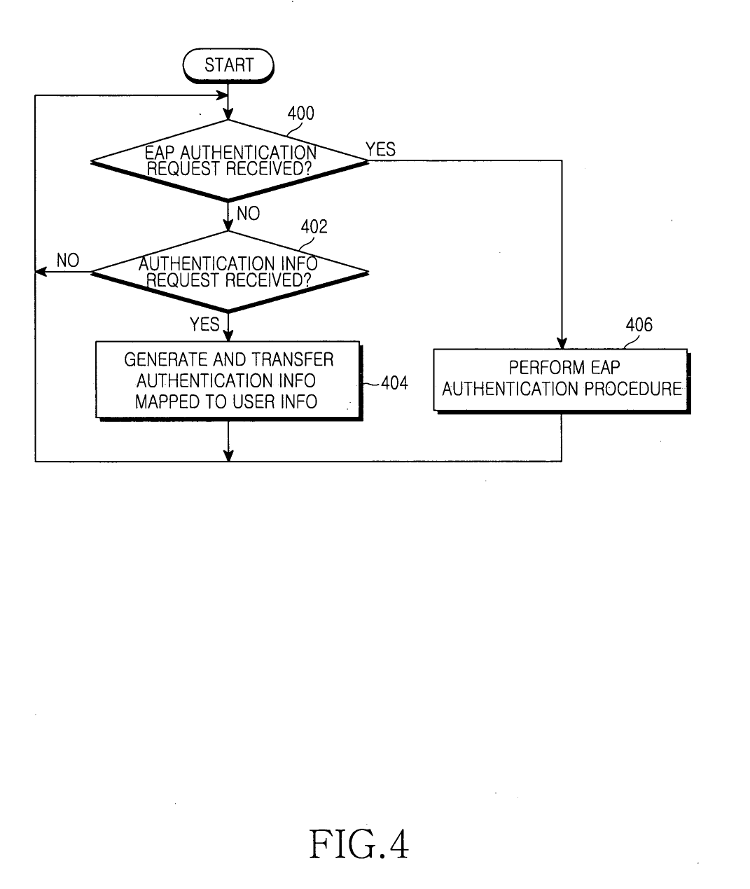

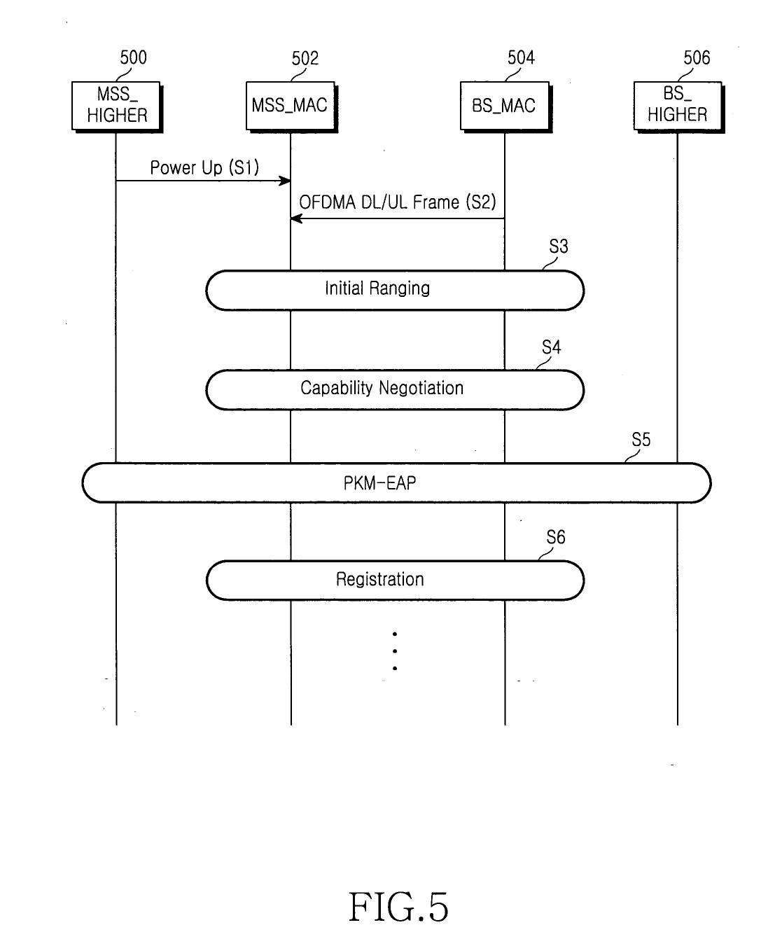

Next, a process for performing authentication in the authentication server will be described with reference to FIG. 4. FIG. 4 is a flowchart illustrating the process for performing authentication in the authentication server in accordance with the present invention. In FIG. 4, the authentication server performs step 404 or 406 when receiving an EAP authentication request or an authentication information request from a terminal in steps 400 and 402.

When receiving the authentication information request from the terminal, the authentication server generates authentication information mapped to user information received from the terminal and then transfers the generated authentication information to the terminal in step 404. When receiving the EAP authentication request from the terminal, the authentication server communicates with the terminal and performs the EAP authentication procedure in step 406.

When the terminal performs an initial entry operation to a network, the terminal and the authentication server share the authentication information required for user authentication, such that the authentication information can be securely shared and can be easily changed and managed in the authentication server.

FIG. 5 is a signal flow diagram illustrating an initial network entry process to which authentication is applied in the communication system in accordance with the present invention. Specifically, FIG. 5 is a signal flow diagram illustrating an initial network entry process to which authentication is applied in Broadband Wireless Access (BWA) communication systems such as an Institute of Electrical and Electronics Engineers (IEEE) 802.16 communication system and a Telecommunication Technology Association (TTA) Wireless Broadband Internet (WiBro) communication system. In FIG. 5, MSS_HIGHER 500 is an upper layer of the terminal, MSS_MAC 502 is a Medium Access Control (MAC) layer of the terminal, BS_MAC 504 is a MAC layer of the BS, and BS_HIGHER 506 is an upper layer of the BS.

When the terminal is powered up, MSS_HIGHER 500 notifies MSS_MAC 502 of a power-up state in step S1. Then, MSS_MAC 502 receives an Orthogonal Frequency Division Multiple Access (OFDMA) Downlink (DL)/Uplink (UL) frame from BS_MAC 504 in step S2.

As an initial network entry operation of the BWA communication system is performed, the initial ranging step S3 of a wireless function and the basic capability negotiation step S4 are executed. When EAP authentication is selected in the basic capability negotiation step S4, the PKM-EAP step S5 is performed. In the PKM-EAP step, user authentication is performed in accordance with the above-described embodiment of the present invention.

When the user authentication is successful in the PKM-EAP step, the BS registration step S6 is performed. As the next steps (not illustrated) of the initial network entry process are performed in the BWA communication system, the terminal accesses the network.

Although the preferred embodiments of the present invention have been disclosed for illustrative purposes, those skilled in the art will appreciate that various modifications, additions, and substitutions are possible, without departing from the scope of the present invention.

Specifically, the example of performing user authentication according to EAP authentication in the BWA communication system in accordance with the present invention has been described. The present invention is also applied to a user authentication scheme in which authentication information is to be stored in advance between the terminal and the authentication server for the user authentication.

In the present invention, there has been described an example of storing authentication information, acquired from the authentication server, in the authentication information memory and using the authentication information for the user authentication in the next initial network entry process. Of course, the authentication information can be newly acquired whenever the user authentication is performed in the initial network entry process without separately storing the acquired authentication information.

In the present invention as described above, a terminal and an authentication server share authentication information required for user authentication when the terminal initially accesses a network, such that the authentication information can be securely shared and can be easily changed and managed in the authentication server.

Therefore, the present invention is not limited to the above-described embodiments, but is defined by the following claims, along with their full scope of equivalents.

What is claimed is:

1. A method for performing authentication in a terminal of a communication system, comprising:
receiving user information while an initial network entry operation is performed;
transferring the received user information to an authentication server;
receiving an authentication information mapped to the user information required for authentication from the authentication server; and
performing authentication with the authentication server using the received authentication information.

2. The method of claim 1, wherein the authentication uses an Extensible Authentication Protocol (EAP) scheme.

3. The method of claim 1, wherein the user information comprises at least one of a user identifier and password.

4. A method for performing authentication in a terminal of a communication system, comprising:
determining whether authentication information required for authentication is stored while an initial network entry operation is performed;
performing authentication with an authentication server using the stored authentication information if the authentication information is stored;
receiving user information to acquire the authentication information if the authentication information is not stored;
transferring the received user information to the authentication server and receiving the authentication information mapped to the user information from the authentication server; and
performing authentication with the authentication server using the acquired authentication information.

5. The method of claim 4, further comprising:
storing the authentication information received from the authentication server.

6. The method of claim 4, wherein the authentication uses an Extensible Authentication Protocol (EAP) scheme.

7. The method of claim 4, wherein the user information comprises at least one of a user identifier and password.

8. A method for performing authentication in an authentication server of a communication system, comprising:
receiving a request for authentication information required for authentication along with user information from a terminal while the terminal performs an initial network entry operation;
generating the authentication information mapped to the user information and transferring the generated authentication information to the terminal; and
performing authentication with the terminal.

9. The method of claim 8, wherein the authentication uses an Extensible Authentication Protocol (EAP) scheme.

10. The method of claim 8, wherein the user information comprises at least one of a user identifier and password.

11. An authentication system for use in a communication system, comprising:
an authentication server; and
a terminal for receiving user information for acquiring authentication information while an initial network entry operation is performed, transferring the received user information to an authentication server, receiving the authentication information mapped to the user information required for authentication from the authentication server, and performing the authentication with authentication server using the received authentication information.

12. The authentication system of claim 11, wherein the terminal comprises:
an authentication information memory for storing the authentication information; and
an authenticator for performing the authentication with the authentication server using the stored authentication information if the authentication information required for authentication is stored in the authentication information memory while the initial network entry operation is performed, receiving user information to acquire the authentication information if the authentication information is not stored in the authentication information memory, transferring the received user information to the authentication server, receiving the authentication information mapped to the user information from the authentication server; and performing authentication with the authentication server.

13. The authentication system of claim 11, wherein the authentication uses an Extensible Authentication Protocol (EAP) scheme.

14. The authentication system of claim 11, wherein the user information comprises at least one of a user identifier and password.

15. The authentication system of claim 12, wherein the authenticator stores the authentication information received from the authentication server in the authentication information memory.
